(19) United States
(12) Patent Application Publication
(10) Pub. No.: US 2010/0178882 A1
(43) Pub. Date: Jul. 15, 2010

(54) RECEIVER

(75) Inventor: Hitoshi KUROYANAGI, Toyota-city (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); ROBERT BOSCH GMBH, Stuttgart (DE)

(21) Appl. No.: 12/643,260

(22) Filed: Dec. 21, 2009

(30) Foreign Application Priority Data
Jan. 14, 2009 (JP) 2009-6042

(51) Int. Cl. H04B 1/034; H04B 1/10

(52) U.S. Cl. 455/98; 455/296

(57) ABSTRACT

A receiver for receiving a radio frequency signal includes a filter, a calculator, and an adjuster. The filter has an adjustable passband and passes the received radio frequency signal within the passband so as to generate a filtered signal. The calculator calculates a signal-to-noise ratio of the received radio frequency signal based on the filtered signal. The adjuster adjusts the passband of the filter in such a manner that the calculated signal-to-noise ratio becomes maximum.

### CROSS REFERENCE TO RELATED APPLICATION

This application is based on and incorporates herein by reference Japanese Patent Application No. 2009-6042 filed on Jan. 14, 2009.

### FIELD OF THE INVENTION

The present invention relates to a receiver for receiving a radio frequency signal.

An example of a receiver for receiving a radio frequency signal is a global positioning system (GPS) receiver that receives a signal from a GPS satellite for positioning. For example, while a GPS signal is modulated on a carrier wave having a frequency of 1575.42 MHz for transmission, the GPS signal has a bandwidth of about 2 MHz. In a GPS receiver disclosed, for example, in US2006/234667 corresponding to JP-2006-222759A, a received radio frequency (RF) signal is filtered by a narrowband filter with a fixed passband to improve a signal-to-noise ratio (SNR) of the GPS signal.

In recent years, there has been an increased demand to perform positioning by using a satellite system other than the GPS, and various types of systems such as GLONASS (Russia) and GALILEO (EU) have been developed. If it is possible to receive signals from satellites of these various types of systems, an improvement in accuracy of positioning can be expected.

However, frequencies of carrier waves and bandwidths of signals to be modulated on the carrier waves generally vary depending on satellite systems. For example, as described above, the GPS signal has the carrier wave frequency of 1575.42 MHz and has the bandwidth of about 2 MHz. In contrast, a satellite signal of the GLONASS has a carrier wave frequency of 1602+0.5625n (n=1, 2, . . . , 24) MHz and has a bandwidth of about 1 MHz.

Therefore, to receive signals from satellites of various types of systems through a common channel, there is a need to increase a passband of a band-limiting filter so as to cover bandwidths of all the signals. However, as the passband of the band-limiting filter is increased, the possibility of receiving an interfering wave is increased.

### SUMMARY OF THE INVENTION

In view of the above, it is an object of the present invention to provide a receiver configured to perform band-limiting to minimize the influence of an interfering wave.

According to an aspect of the present invention, a receiver for receiving a radio frequency signal includes a filter, a calculator, and an adjuster. The filter has an adjustable passband and passes the received radio frequency signal within the passband so as to generate a filtered signal. The calculator calculates a signal-to-noise ratio of the received radio frequency signal based on the filtered signal. The adjuster adjusts the passband of the filter in such a manner that the calculated signal-to-noise ratio becomes maximum.

### BRIEF DESCRIPTION OF THE DRAWINGS

The above and other objectives, features and advantages of the present invention will become more apparent from the following detailed description made with check to the accompanying drawings. In the drawings:

FIG. 1 is a block diagram illustrating a receiver according to an embodiment of the present invention;

FIG. 2 is a diagram illustrating a distribution of a received L1 GPS signal;

FIG. 3 is a flow chart illustrating a procedure to adjust an adjustable filter of the receiver; and

FIG. 4A is a diagram illustrating a manner in which a passband of the adjustable filter is increased, and FIG. 4B is a diagram illustrating a change in a signal-to-noise ratio with an increase in the passband of the adjustable filter.

### DETAILED DESCRIPTION OF THE PREFERRED EMBODIMENT

A receiver 1 according to an embodiment of the present invention is described below with reference to the drawings. The receiver 1 is configured to receive satellite signals from various types of satellite systems such as GLONASS (Russia) and GALILEO (EU). It is noted that the receiver 1 can be configured as a receiver for other communications including a cellular phone, FM broadcasting, electronic toll collection (ETC), and a vehicle information and communication system (VICS).

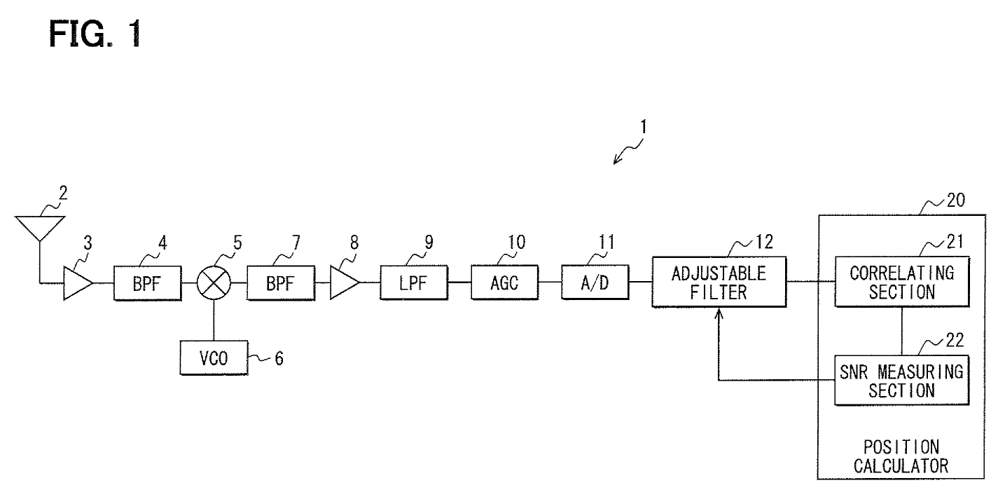

FIG. 1 is a block diagram of the receiver 1. The receiver 1 has multiple reception channels in order to simultaneously receive multiple satellite signals. Since each reception channel has the same configuration, FIG. 1 depicts only one reception channel. The receiver 1 simultaneously receives the satellite signals from multiple satellites and measures pseudoranges to the satellites. Further, the receiver 1 performs positioning calculation based on the measured pseudoranges, calculates an estimated error value with respect to a position solution, and calculates final position based on the position solution and the estimated error value.

In FIG. 1, an antenna 2 receives multiple satellite signals (RF signals) having different frequencies and outputs the received RF signals to a low-noise amplifier (LNA) 3. For example, the antenna 2 can receive both a L1 wave (1575.42 MHz) of the GPS and a L1 wave (1602+0.5625n (n=1, 2, . . . , 24) MHz) of the GLONASS. The LNA 3 amplifies the RF signal received by the antenna 2 and then outputs the RF signal to a band-pass filter (BPF) 4. The BPF 4 has a frequency passband in which carrier wave frequencies of all the satellite signals exist.

A voltage-controlled oscillator (VCO) 6 generates a conversion signal based on a predetermined reference frequency and outputs the conversion signal to a mixer 5. The conversion signal has a predetermined frequency with respect to a frequency of the RF signal filtered by the BPF 4. The mixer 5 performs downconverting by mixing the RF signal passing through the BPF 4 and the conversion signal generated by the VCO 6, thereby generating an intermediate frequency (IF) signal.

The IF signal generated by the mixer 5 is inputted to a band-pass filter (BPF) 7. Like the BPF 4, the BPF 7 has a frequency passband that allows the carrier wave frequencies of all the satellite signals in the IF signal to pass through the BPF 7. In this way, a frequency component corresponding to the carrier wave frequency of the RF signal to be received is extracted through two band-pass filters, BPF 4 and BPF 7. Alternatively, the BPF 7 can be omitted.

The IF signal outputted from the BPF 7 is inputted to an IF amplifier 8 and amplified by the IF amplifier 8. The IF signal amplified by the IF amplifier 8 is inputted to a low-pass filter (LPF) 9. The LPF 9 has a predetermined cutoff frequency and passes a frequency component of the IF signal below the cutoff frequency. The IF signal passing through the LPF 9 is inputted to an amplifier 10 having an automatic gain control (AGC) function. The amplifier 10 amplifies the inputted IF signal under gain control so that the amplified IF signal can have a predetermined amplitude. The amplifier 10 outputs the amplified IF signal to an analog-to-digital (A/D) converter 11. The A/D converter 11 performs A/D conversion by sampling the inputted IF signal at a predetermined sampling frequency, thereby converting the IF signal into a digital signal. The IF signal digitized by the A/D converter 11 is inputted to a adjustable filter 12.

The adjustable filter 12 is a band-pass filter formed with a digital filter such as a finite impulse response (FIR) filter, an infinite impulse response (11R) filter, or a cascaded integrator-comb (CIC) filter. A center frequency and a bandwidth of a passband of the adjustable filter 12 can be adjusted according to a control signal received from a position calculator 20.

Alternatively, for example, the adjustable filter 12 can be formed with a set of a Fourier transform device and an inverse Fourier transform device instead of such a digital filter. In a case where a set of the Fourier transform device and the inverse Fourier transform device is used as the adjustable filter 12, a power spectrum of a frequency to be blocked in frequencies generated by the Fourier transform device is substituted with zero. The power spectrum corrected by zero substitution is inverse Fourier transformed by the inverse Fourier transform device so that the digital IF signal can have frequency components only in a desired band of frequencies. When a set of the Fourier transform device and the inverse Fourier transform device is used as the adjustable filter 12, the amount of calculations is increased, but the adjustable filter 12 can have a sharp attenuation characteristic at the cutoff frequency.

The IF signal filtered by the adjustable filter 12 is inputted to the position calculator 20. The position calculator 20 includes a correlating section 21 and a SNR measuring section 22.

Although not shown in the drawings, the correlating section 21 includes a carrier correlating portion and a code correlating portion. The carrier correlating portion has an numerically-controlled oscillator (NCO) that generates a clock signal while controlling a frequency and a phase of the clock signal. In the carrier correlating portion, the inputted digital IF signal is multiplied by the clock signal generated by the NCO. Although not shown in the drawings, the NCO is controlled by a central processing unit (CPU) of the position calculator 20 in such a manner that the frequency and the phase of the clock signal generated by the NCO can be equal to the carrier wave frequency of the inputted digital IF signal. Thus, the carrier wave frequency component is removed from an output signal of the carrier correlating portion. The output signal of the carrier correlating portion is supplied to the code correlating portion.

Although not shown in the drawings, the code correlating portion includes a code generator and an numerically-controlled oscillator (NCO). The code generator generates a pseudo-random code based on a clock frequency of a code generated by the NCO. The generated pseudo-random code is equivalent to a code used for modulation of a satellite signal of a target satellite to be captured. In the code correlating portion, the pseudo-random code generated by the code generator is multiplied by the output signal of the carrier correlating portion. An output signal of the code correlating portion is inputted to the CPU, and the CPU controls the NCO and the code generator in such a manner that a frequency and a phase of the pseudo-random code can be equal to those of the output signal of the carrier correlating portion. In such an approach, a signal containing navigation data can be received by the reception channel of the receiver 1. The CPU extracts the navigation data containing time information of a satellite clock and satellite position information (ephemeris data) from the signal received by the reception channel. Further, the CPU calculates a pseudorange to the satellite based on the navigation data and performs positioning calculation based on the pseudoranges to four or more satellites.

For example, the target satellite can be determined based on the fact that there is a correlation when specific codes to satellites are generated in turn. For another example, the target satellite can be determined based on the result of frequency analysis of signals received in advance. For another example, a satellite capable of being captured can be estimated based on a satellite orbit, a present position, and a present time, and then the target satellite can be determined based on the result of the estimation.

As mentioned previously, the position calculator 20 further includes the SNR measuring section 22. The SNR measuring section 22 receives an output signal of the correlating section 21 and calculates a signal-to-noise ratio (SNR) by calculating a ratio between an output signal value obtained when there is a correlation between a specific code to the target satellite and the pseudo-random code and an output signal value obtained when there is no correlation between the specific code and the pseudo-random code. Then, the position calculator 20 limits the passband of the adjustable filter 12 based on the carrier wave frequency of the satellite signal from the target satellite and the signal-to-noise ratio calculated by the SNR measuring section 22.

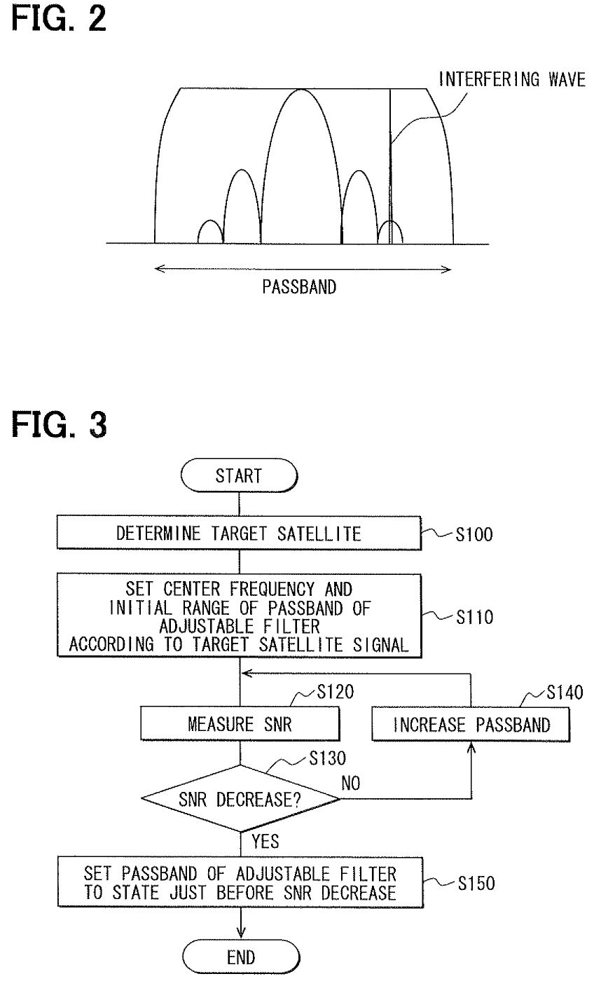

In a condition where there is only thermal noise without an interfering wave, the signal-to-noise ratio is increased as the passband of the adjustable filter 12 is increased from a center of a carrier wave frequency of a reception signal. A reason for this is that, for example, the L1 wave of the GPS has a main lobe in the center of the carrier wave frequency and has a side lobe at predetermined frequency intervals, as shown in FIG. 2. However, if an interfering wave exists in the passband of the adjustable filter 12, the signal-to-noise ratio is reduced (degraded) due to the influence of the interfering wave.

Therefore, according to the embodiment, band-limiting suitable to reduce the influence of the interfering wave is performed by adjusting the passband of the adjustable filter 12 in such a manner that the signal-to-noise ratio can become maximum. The adjustment of the passband of the adjustable filter 12 is described in detail below.

FIG. 3 is a flow chart illustrating a procedure to adjust the passband of the adjustable filter 12. The procedure starts at S100, where the target satellite to be captured is determined. Then, the procedure proceeds to S110, where the center frequency of the passband of the adjustable filter 12 is determined to correspond to the carrier wave frequency of the satellite signal from the target satellite. Also, at S110, an initial bandwidth (range) of the passband of the adjustable filter 12 is determined. Thus, the adjustable filter 12 passes only a frequency component within the initial bandwidth with respect to the center frequency.

Next, the procedure proceeds to S120, where the signal-to-noise ratio is measured (calculated) based on the output signal of the correlating section 21. Then, the procedure proceeds to S130, where it is determined whether the signal-to-noise ratio calculated at the present time is greater or smaller than a previous signal-to-noise ratio that is calculated at the previous time. If it is determined that the present signal-to-noise ratio is greater than the previous signal-to-noise ratio corresponding to NO at S130, the procedure proceeds to S140. It is noted that when the procedure proceeds from S120 to S130 for the first time (i.e., when there is no previous signal-to-noise ratio), the procedure always proceeds to S140.

At S140, the passband of the adjustable filter 12 is increased by a predetermined bandwidth. After S140, the procedure returns to S120 so that S120 and S130 can be repeated to observe a change in the signal-to-noise ratio.

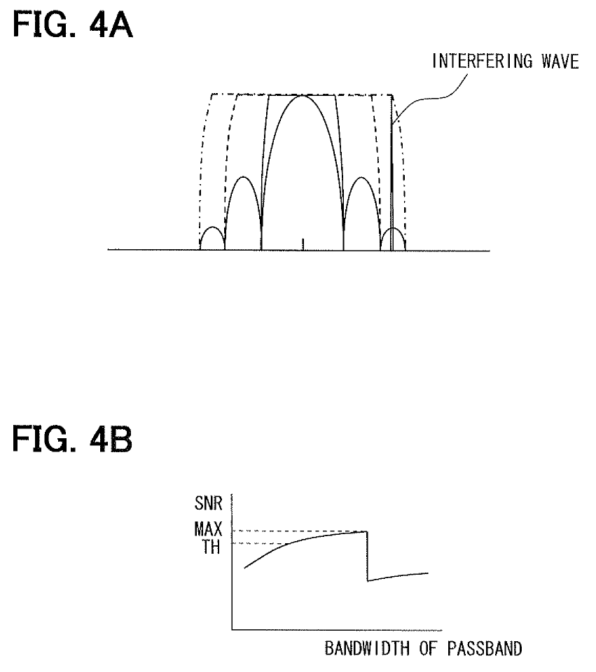

In such an approach, the passband of the adjustable filter 12 is continuously increased while the signal-to-noise ratio is increased with the increase in the passband of the adjustable filter 12. Then, as a result of the increase in the passband of the adjustable filter 12, when the interfering wave exists in the passband of the adjustable filter 12 as shown in FIG. 4A, the signal-to-noise ratio sharply decreases as shown in FIG. 4B.

Therefore, if it is determined that the present signal-to-noise ratio is smaller than the previous signal-to-noise ratio corresponding to YES at S130, the procedure proceeds to S150. At S150, the adjustable filter 12 is set to a passband just before the decrease in the signal-to-noise ratio. Thus, the passband of the adjustable filter 12 becomes maximum in such a manner that the interfering wave does not exist in the passband of the adjustable filter 12.

The embodiment described above can be modified in various ways, for example, as follows.

In the embodiment, the adjustable filter 12 as a digital filter is connected to the output side of the ND converter 11, and the center frequency and the passband width of the adjustable filter 12 are adjusted. Alternatively, the center frequencies and the passband widths of the BPF 4 and BPF 7 as an analog filter can be adjusted so that the BPF 4 and BPF 7 can pass frequency components of the target satellite signals while preventing the interfering wave.

In the embodiment, the receiver 1 is configured to receive L1 waves of the GPS and the GLONASS. Alternatively, the receiver 1 can be configured to receive a signal of other frequency band such as a L2 wave.

In the embodiment, as shown in FIG. 4B, the passband of the adjustable filter 12 is adjusted in such a manner that the signal-to-noise ratio can have a maximum value MAX. Alternatively, the passband of the adjustable filter 12 can be adjusted in such a manner that the signal-to-noise ratio can exceed a predetermined threshold value TH less than the maximum value MAX depending on the intended use. The predetermined threshold value TH corresponds to a required minimum reception sensitivity. In such an approach, unexpected external interfering waves can be prevented while ensuring the required minimum reception sensitivity.

Such changes and modifications are to be understood as being within the scope of the present invention as defined by the appended claims.

What is claimed is:

1. A receiver for receiving a radio frequency signal, the receiver comprising:
a filter having an adjustable passband and configured to pass the received radio frequency signal within the passband so as to generate a filtered signal;
a calculator configured to calculate a signal-to-noise ratio of the received radio frequency signal based on the filtered signal; and
an adjuster configured to adjust the passband of the filter in such a manner that the calculated signal-to-noise ratio becomes maximum.

2. The receiver according to claim 1, wherein
the adjuster continuously increases the passband of the filter until the calculated signal-to-noise ratio decreases, and
when the calculated signal-to-noise ratio decreases, the adjuster sets the passband of the filter to a state just before the calculated signal-to-noise ratio starts to decrease.

3. The receiver according to claim 2, wherein
the radio frequency signal comprises a plurality of different types of radio frequency signals having different frequencies,
the adjuster determines a center frequency of the passband of the filter based on a type of the received radio frequency signal, and
the adjuster increases the passband of the filter with respect to the center frequency.

4. The receiver according to claim 1, wherein
the radio frequency signal is modulated with a first code before being received, and
the calculator calculates the signal-to-noise ratio using a signal value obtained by demodulating the filtered signal with the first code and a signal value obtained by demodulating the filtered signal with a second code different from the first code.

5. The receiver according to claim 1, wherein
the radio frequency signal is transmitted from a satellite.
